(19) United States
(12) Patent Application Publication
(10) Pub. No.: US 2009/0064316 A1
(43) Pub. Date: Mar. 5, 2009

(54) Method and Apparatus for Enhancing Information Security in a Computer System

(76) Inventors: Wen-Hsin Liao, Taipei Hsien (TW); Mei-Chen Lin, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/927,595

(22) Filed: Oct. 29, 2007

(30) Foreign Application Priority Data
Aug. 27, 2007 (TW) 096131674

(51) Int. Cl. G06F 21/00

(52) U.S. Cl. 726/18

(57) ABSTRACT

A method of enhancing information security in a computer system comprises receiving an input signal, reading a starting password, comparing the input signal with the starting password for generating a comparison result, and controlling an operating status of a basic input and output system of the computer system according to the comparison result.

### BACKGROUND OF THE INVENTION

1. Field of the Invention

The present invention relates to a method and apparatus for enhancing information security in a computer system, and more particularly to a method and apparatus for preventing problems caused by unknown people intending to crack boot password through a crisis mode of a basic input and output system.

2. Description of the Prior Art

When a user wants to use a computer system, the user has to turn on a power switch and begins to use the computer after a boot process is completed. To maintain information security, the user can setup a boot password or a login password of an operating system for preventing information in the computer system from being stolen. For example, after the computer system performs the boot process and enters the operating system, the operating system will request the user for input of a username and a password and decide, so as to determine whether the user is qualified to use the computer system by checking validity of the username and password. Such operations can prevent unauthorized users from entering the operating system and avoid information in the computer system being stolen. However, there is a weakpoint in the prior art because some backdoor programs can access information in the computer system by bypassing the operation system after the computer system performs the boot process. In comparison, the method of setting up the boot password is requesting users to input a boot password by a basic input and output system (BIOS) after the computer system performs the boot process. If the input is correct, the follow-up processes, such as power-on self test (POST), plug and play test and hardware configuration, can be performed to enter the operating system. If the input is not correct, the BIOS requests users to input password again or to perform a shutdown process. In other words, by the method of setting up the boot password of the computer system, the computer system requests users to input a boot password before entering the operating system, to avoid the backdoor programs accessing information in the computer system.

Therefore, setting up the boot password can enhance information security in the computer system and prevent information in the computer system from being stolen. However, in some situations, such as when a user forgets the password or an engineer performs repairing works, the check scheme of the boot password can be omitted by removing a battery of the computer system for erasing records in the BIOS or entering a crisis mode. The crisis mode is a special operation mode in the BIOS and is primarily utilized for engineers to check, update, or repair the BIOS. When the computer system is turned on while the BIOS does not yet check the boot password, users can enter the crisis mode for repairing or updating the BIOS through a verification device or input of a specific string. For detail operation, please refer to FIG. 1. FIG. 1 is a schematic diagram of a boot process 10 of a computer system according to the prior art. The boot process 10 comprises the following steps:

Step 100: Start.

Step 102: Determine if the power switch of the computer system is turned on. If true, perform step 104; else, keep detecting.

Step 104: Determine if the computer system enters the crisis mode. If true, perform step 106; else, perform step 108.

Step 106: Check, update, or repair the BIOS of the computer system.

Step 108: Determine if the computer system had been set up a boot password. If true, perform step 110; else, perform step 114.

Step 110: Indicate and wait for input of a string by the user, and then perform step 112.

Step 112: Check if the received string conforms to the boot password. If true, perform step 114; else, perform step 116.

Step 114: Perform the boot process of the BIOS.

Step 116: End.

From the above, after the power switch of the computer system is turned on, the user can enter the crisis mode to check, update, or repair the BIOS through a verification device or input of a specific string before the computer system enters the boot process of the BIOS. In other words, the user can simply enter the crisis mode by input of the specific string before the BIOS checks the boot password. In such a case, even though the boot password is already set up, people can still steal information of the computer by entering the crisis mode and cracking the check scheme of the boot password through updating the BIOS, which may result in a huge loss for individuals or enterprises.

### SUMMARY OF THE INVENTION

It is therefore a primary objective of the claimed invention to provide a method and apparatus for enhancing information security in a computer system.

The present invention discloses a method of enhancing information security in a computer system, which comprises receiving an input signal, reading a starting password, comparing the input signal with the starting password for generating a comparison result, and controlling an operating status of a basic input and output system of the computer system according to the comparison result.

The present invention further discloses an electronic device for enhancing information security in a computer system, which comprises a reception unit for receiving an input signal, a reading unit for reading a starting password, a comparison unit coupled to the reception unit and the reading unit, for comparing the input signal with the starting password for generating a comparison result, and a control unit coupled to the comparison unit and a basic input and output system (BIOS) of the computer system, for controlling an operating status of the BIOS according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a boot process of a computer system according to the prior art.

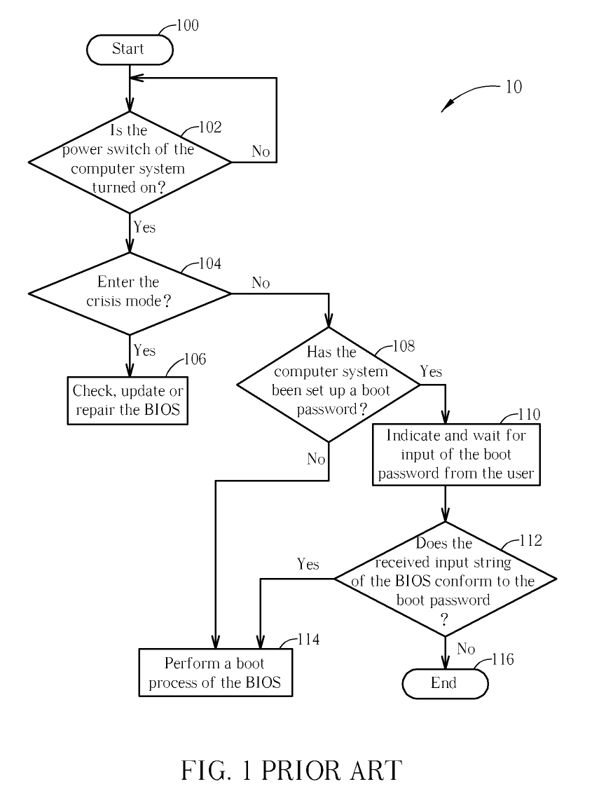

FIG. 2 is a schematic diagram of a process in accordance with an embodiment of the present invention.

FIG. 3 is a functional block diagram of an information security enhancement device of a computer system in accordance with an embodiment of the present invention.

FIG. 4 is a functional block diagram of an application embodiment of the information security enhancement device shown in FIG. 3.

FIG. 5 is a schematic diagram of a process in accordance with an embodiment of the present invention.

FIG. 6 is a schematic diagram of a boot process of a computer system in accordance with an embodiment of the present invention.

FIG. 7 is a functional block diagram of an information security enhancement device of a computer system in accordance with the embodiment of the present invention.

FIG. 8 is a functional block diagram of an application embodiment of the information security enhancement device shown in FIG. 7.

### DETAILED DESCRIPTION

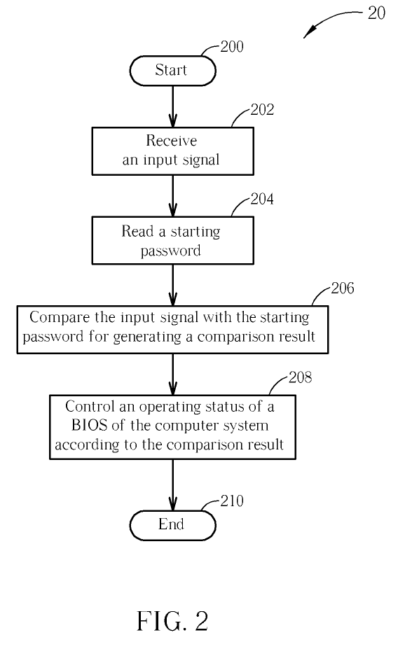

Please refer to FIG. 2. FIG. 2 is a schematic diagram of a process 20 in accordance with an embodiment of the present invention. The process 20 is utilized for enhancing information security in a computer system, and comprises the following steps:

Step 200: Start.

Step 202: Receive an input signal.

Step 204: Read a starting password.

Step 206: Compare the input signal with the starting password for generating a comparison result.

Step 208: Control an operating status of a BIOS of the computer system according to the comparison result.

Step 210: End.

According to the process 20, the present invention receives an input signal inputted by a user and controls an operating status of the BIOS according to the comparison result of the input signal and the starting password. In other words, the present invention first determines if the input signal conforms to the starting password before operations of the BIOS, and controls the following operations accordingly. Therefore, the present invention can avoid people cracking the boot password through the crisis mode of the BIOS. Preferably, the input signal is received through a keyboard of the computer system, and the starting password is obtained from a storage device of the computer system.

In the prior art, even if the boot password is set up in the BIOS, the user can enter the crisis mode and update the BIOS for cracking the check scheme of the boot password through a specific verification device or input of a specific string. In comparison, in the process 20 of the present invention, the computer system enters the BIOS only when the input signal from the user conforms to the starting password. Therefore, as long as the starting password is not stolen, even if unknown people obtain the verification device or the specific string for the crisis mode, the present invention can still perform the check scheme of the starting password for avoiding unauthorized users entering the computer system, so as to prevent data or information of the computer system from being stolen, which may cause a huge loss of individuals or enterprises.

Note that, the process 20 is an exemplary embodiment of the present invention, and those skilled in the art can make alternations and modifications accordingly. For example, in step 208, if the input signal received by the computer system conforms to the starting password, the computer system performs the boot process of the BIOS, such as power-on self test, plug and play test and hardware configuration, otherwise the computer system performs the shutdown process of the BIOS. Moreover, the present invention can count times of the situation that the input signal does not conform to the starting password and output an alarm signal, such as a voice or a flash when the counted times is greater than a default value. Or, the present invention can record information of the inconformity of the input signal and the starting password, such as occurrence time of the inconformity, for notifying the legal users.

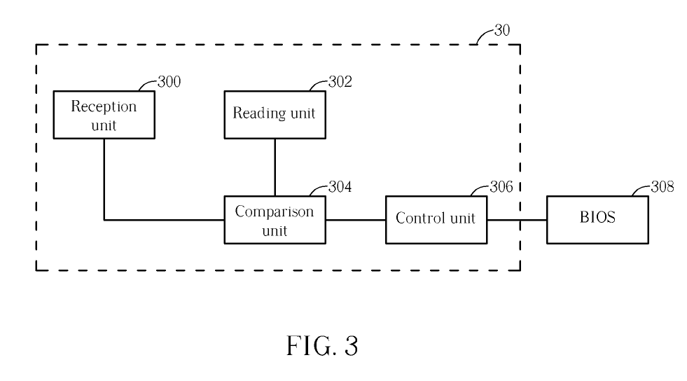

Therefore, using the process, the computer system performs the check scheme of the starting password before the computer system enters the BIOS, which can avoid unauthorized users entering the computer system, prevent information of the computer system from being stolen, which may cause a huge loss of individuals or enterprises. As to implementation of the process 20, please refer to FIG. 3. FIG. 3 is a functional block diagram of an information security enhancement device 30 of a computer system in accordance with an embodiment of the present invention. The information security enhancement device 30 is utilized for enhancing information security of the computer system, which is preferably embedded in a keyboard controller of the computer system. The information security enhancement device 30 comprises a reception unit 300, a reading unit 302, a comparison unit 304, and a control unit 306. The reception unit 300 is utilized for receiving an input signal. The reading unit 302 is utilized for reading a starting password. The comparison unit 304 is coupled to the reception unit 300 and the reading unit 302, and utilized for comparing the input signal with the starting password for generating a comparison result. The control unit 306 is coupled to the comparison unit 304 and a BIOS 308, and utilized for controlling the operating status of the BIOS 308 according to the comparison result generated by the comparison unit 304.

Therefore, in the information security enhancement device 30, the comparison unit 304 can compare the input signal received by the reception unit 300 with the starting password received by the reading unit 302, and the control unit 306 can control the operating status of the BIOS 308 according to the comparison result generated by the comparison unit 304. In other words, the control unit 306 of the information security enhancement device 30 determines whether the input signal conforms to the starting password before the BIOS 308 works, and controls the operating status of the BIOS 308 accordingly. For example, if the input signal received by the reception unit 300 conforms to the starting password received by the reading unit 302, the control unit 306 can control the BIOS to perform the boot process including power-on self test, plug and play test, hardware configuration, etc. Oppositely, if the input signal received by the reception unit 300 does not conform to the starting password received by the reading unit 302, the control unit 306 can control the BIOS to perform the shutdown process. As a result, the information security enhancement device 30 can avoid the problem that unknown people crack the boot password through the crisis mode of the BIOS 308.

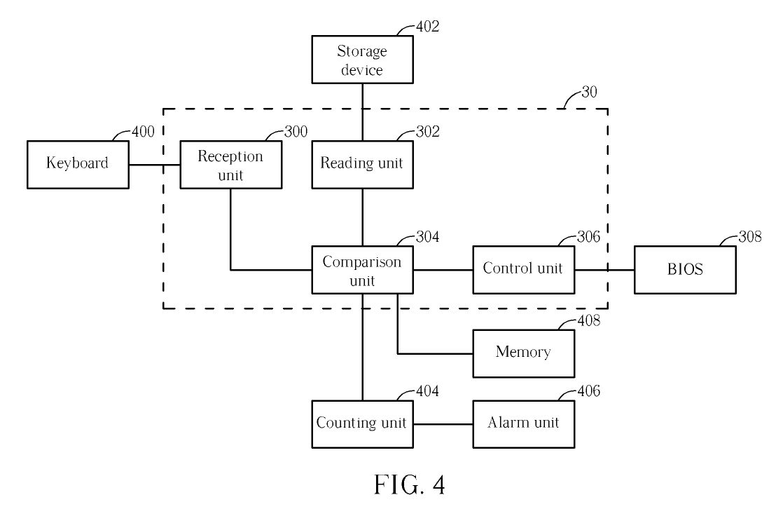

Note that, the information security enhancement device 30 shown in FIG. 3 is an exemplary embodiment of the present invention, and those skilled in the art can make alterations and modifications accordingly. For example, please refer to FIG. 4. FIG. 4 illustrates a schematic diagram of an application embodiment of the information security enhancement device 30. In FIG. 4, the information security enhancement device 30 is further coupled to a keyboard 400, a storage device 402, a counting device 404, an alarm unit 406, and a memory 408. The keyboard 400 is coupled to the reception unit 300, and utilized for receiving the input signal from the user and transmitting the input signal to the reception unit 300. The storage device 402 is coupled to the reading unit 302, and utilized for storing the starting password. The counting unit 404 is coupled to the comparison unit 304, and utilized for counting times of the situation that the input signal does not conform to the starting password. The alarm unit 406 is coupled to the counting unit 404, and utilized for outputting an alarm signal, such as a voice or a flash when the counted times is greater than a default value according to the counting result of the counting unit 404. Moreover, the memory 408 is coupled to the comparison unit 304, and utilized for recording information of the inconformity of the input signal and the starting password, such as occurrence time of the inconformity. Therefore, when the input signal received by the computer system does not conform to the starting password, the counting unit 404 can count times of the inconformity and the alarm unit 406 can output an alarm signal, such as a voice or a flash, when the counted times is greater than a default value. Moreover, the memory 408 can record information of the inconformity of the input signal and the starting password, such as occurrence time, for notifying the legal users.

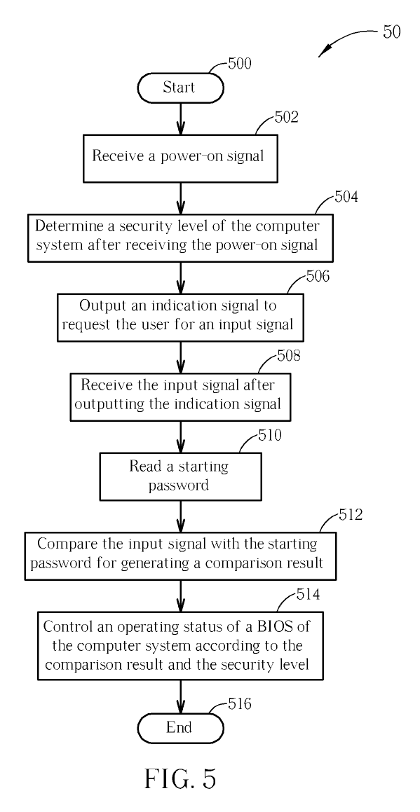

Please refer to FIG. 5. FIG. 5 is a schematic diagram of a process 50 in accordance with an embodiment of the present invention. The process 50 is utilized for enhancing information security in a computer system, which comprises the following steps:

Step 500: Start.

Step 502: Receive a power-on signal.

Step 504: Determine a security level of the computer system after receiving the power-on signal.

Step 506: Output an indication signal according to the security level of the computer system.

Step 508: Receive an input signal after outputting the indication signal.

Step 510: Read a starting password.

Step 512: Compare the input signal with the starting password for generating a comparison result.

Step 514: Control an operating status of a BIOS of the computer system according to the comparison result.

Step 516: End.

In the process 50, the power switch of the computer system is turned on after the computer system receives the power-on signal. After the computer system is turned on, the process 50 determines the security level of the computer system and then outputs an indication signal for indicating a password-protecting message for requesting the input signal from a user according to the security level of the computer. Then, the process 50 reads the starting password of the computer system and compares the starting password with the input signal for generating a comparison result. At last, the process 50 controls the operating status of the BIOS according to the comparison result and the security level of the computer system. In other words, using the process 50, the computer system indicates the user to input password for the check scheme of the starting password when the computer system is turned on but before the BIOS operates, and controls following operations accordingly. As a result, the present invention can avoid unknown people cracking the boot password through the crisis mode of the BIOS. Preferably, the input signal is received by a keyboard of the computer system, and the starting password is received from a storage device in the computer system.

Therefore, using the process 50, when the computer system is turned on, the computer system enters the BIOS after the input signal from the user conforms to the starting password. As a result, as long as the starting password is not stolen, even if the unknown people obtain the verification device or the specific string for the crisis mode, the present invention can still perform the check scheme of the starting password for avoiding unauthorized users entering the computer system, so as to prevent information of the computer system from being stolen and a huge loss of individuals or enterprises.

Note that, the process 50 is an exemplary embodiment of the present invention, and those skilled in the art can make alternations and modifications accordingly. For example, the indication signal outputted from the computer system under the protection of the starting password can be a voice or a flash. In addition, step 514 can have three implementations as follows. First, if the computer system is protected by the starting password, and the input signal received by the computer system conforms to the starting password, the computer system performs the boot process of the BIOS, such as power-on self test, plug and play test and hardware configuration. Second, if the computer system is protected by the starting password, and the input signal received by the computer system does not conform to the starting password, the computer system performs the shutdown process of the BIOS. Third, if the computer system is not protected by the starting password, the computer system directly performs the boot process of the BIOS. Moreover, if the input signal received by the computer system does not conform to the starting password, the present invention can count times of the situation that the input signal does not conform to the starting password and output an alarm signal, such as a voice or a flash when the counted times is greater than a default value. Also, the present invention can record information of the inconformity of the input signal and the starting password, such as occurrence time, for notifying the legal users.

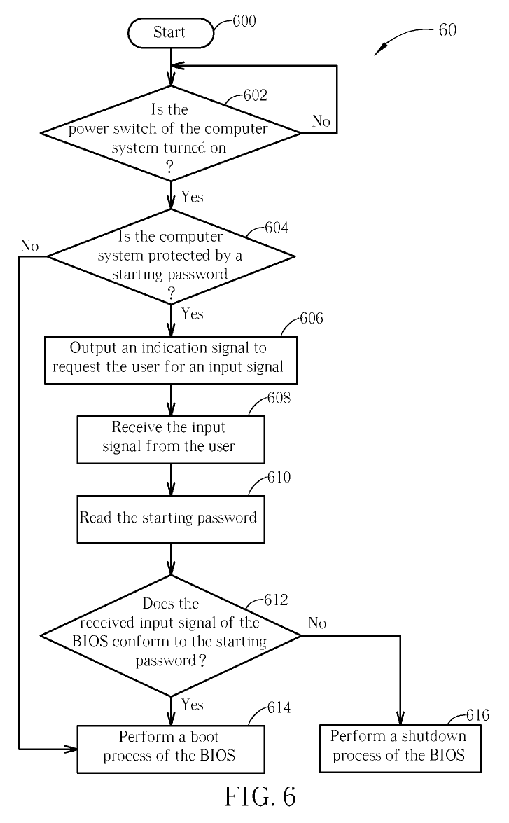

The abovementioned description can be concluded into a boot process 60 shown in FIG. 6. The boot process 60 is derived according to the process 50 and utilized for enhancing information security of the computer system, which comprises the following steps:

Step 600: Start.

Step 602: Determine if the power switch of the computer system is turned on. If true, perform the step 604; else keep detecting.

Step 604: Determine if the computer system is protected by the starting password. If true, perform the step 606; else, perform the step 614.

Step 606: Output an indication signal for requesting the user for the input signal.

Step 608: Receive an input signal from the user.

Step 610: Read a starting password.

Step 612: Determine if the input signal from the user conforms to the starting password. If true perform the step 614, else perform the step 616.

Step 614: Perform the boot process of the BIOS.

Step 616: Perform the shutdown process of the BIOS.

From the above, when the computer system is turned on, the boot process 60 determines if the computer system is protected by the starting password. If the computer system is protected by the starting password, the computer system outputs an indication signal for requesting the user for the input signal; otherwise the computer system directly performs the boot process. Next, the boot process 60 accesses the starting password of the computer system and compares the starting password with the input signal. If the input signal conforms to the starting password, the computer system performs the boot process of the BIOS; otherwise the computer system performs the shutdown process of the BIOS. In other words, using the boot process 60, the computer system indicates the user to input password for the check scheme of the starting password when the computer system is turned on but before the BIOS operates. As a result, the boot process 60 can avoid the problem that unknown people crack the boot password through the crisis mode of the BIOS.

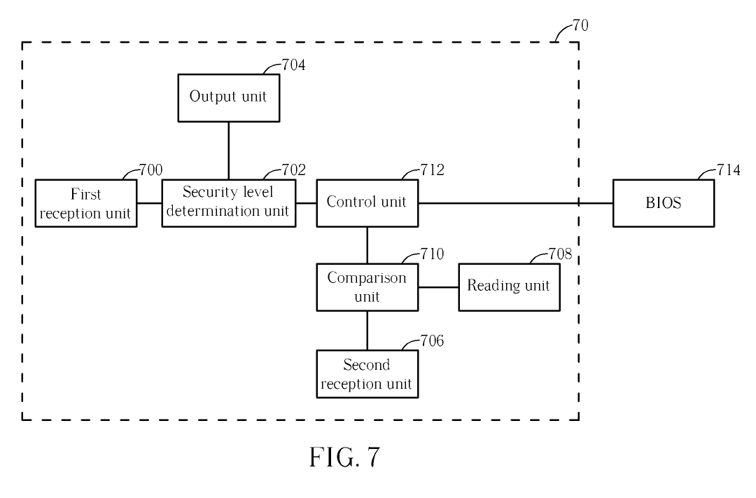

As to hardware implementation of the process 50 of FIG. 5, please refer to FIG. 7. FIG. 7 is a functional block diagram of an information security enhancement device 70 of a computer system in accordance with an embodiment of the present invention. The information security enhancement device 70 is utilized for enhancing information security of the computer system, which is preferably embedded in a keyboard controller of the computer system. The information security enhancement device 70 comprises a first reception unit 700, a security level determination unit 702, an output unit 704, a second reception unit 706, a reading unit 708, a comparison unit 710, and a control unit 712. The first reception unit 700 is utilized for receiving a power-on signal, and the security level determination unit 702 is utilized for determining a security level of the computer system after the first reception unit 700 receives the power-on signal. The output unit 704 is coupled to the security level determination unit 702, and utilized for outputting an indication signal for indicating a password-protecting message and requesting an input signal from the user according the security level of the computer system. The second reception unit 706 is utilized for receiving the input signal after the output unit 704 outputs the indication signal. The reading unit 708 is utilized for reading a starting password. The comparison unit 710 is coupled to the second reception unit 706 and the reading unit 708, and utilized for comparing the input signal with the starting password for generating a comparison result. The control unit 712 is coupled to the security level determination unit 702, the comparison unit 710, and a basic input and output system (BIOS) 714, and is utilized for controlling the operating status of the BIOS 714 according to the comparison result generated by the comparison unit 710 and the determination result generated by the security level determination unit 702.

In the information security enhancement device 70, the security level determination unit 702 can determine the security level of the computer system, the comparison unit 710 can compare the input signal with the starting password, the control unit 712 can control the operating status of the BIOS 714 according to the security level of the computer system and the comparison result of the input signal and the starting password. In other words, if the computer system is protected by the starting password, when the computer system is turned on and the BIOS does not yet operate, the information security enhancement device 70 can indicate the user to input a password for performing the check scheme of the starting password and then control the following operation. As a result, as long as the starting password is not stolen, even if the unknown people obtain the verification device or the specific string for the crisis mode, the information security enhancement device 70 can still perform the check scheme of the starting password for avoiding unauthorized users entering the computer system, so as to prevent information of the computer system from being stolen and a huge loss of individuals or enterprises.

Note that, FIG. 7 shows a functional block diagram of the information security enhancement device 70, and those skilled in the art can make alternations and modifications accordingly. For example, the output unit 704 can be an LED for generating a flash signal or a speaker for generating a voice signal. Moreover, the control unit 712 has three implementations as follows. First, if the computer system is protected by the starting password, and the input signal received by the computer system conforms to the starting password, the computer system performs the boot process of the BIOS, such as power-on self test, plug and play test and hardware configuration. Second, if the computer system is protected by the starting password, and the input signal received by the computer system does not conform to the starting password, the computer system performs the shutdown process of the BIOS. Third, if the computer system is not protected by the starting password, the computer system directly performs the boot process of the BIOS.

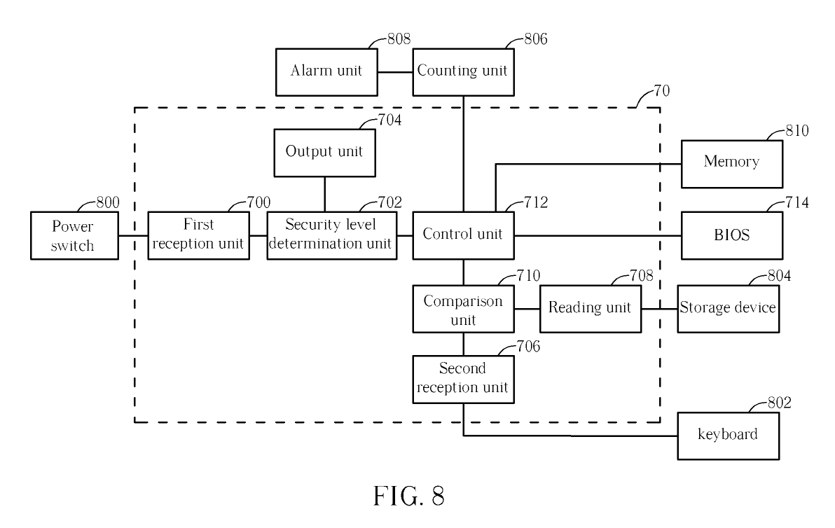

In addition, please refer to FIG. 8. FIG. 8 illustrates an application embodiment of the information security enhancement device 70 shown in FIG. 7. In FIG. 8, the information security enhancement device 70 is coupled to a power switch 800, a keyboard 802, a storage device 804, a counting device 806, an alarm unit 808, and a memory 810. The power switch 800 is coupled to the first reception unit 700, and utilized for generating a power-on signal. The keyboard 802 is coupled to the second reception unit 706, and utilized for receiving the input signal from the user and transmitting the input signal to the second reception unit 706. The storage device 804 is coupled to the reading unit 708, and utilized for storing the starting password. The counting unit 806 is coupled to the control unit 712, and utilized for counting times of the situation that the input signal does not conform to the starting password. The alarm unit 808 is coupled to the counting unit 806, and utilized for outputting an alarm signal, such as a voice or a flash when the counted times of the situation that the input signal received by the second reception unit 706 does not conform to the starting password is greater than a default value according to the counting result of the counting unit 806. The memory 810 is coupled to the control unit 712, and utilized for recording information of the inconformity of the input signal and the starting password, such as occurrence time of the inconformity. Therefore, when the input signal received by the computer system does not conform to the starting password, the counting unit 806 counts times of the inconformity, and the alarm unit 808 outputs an alarm signal, such as a voice or a flash when the times of inconformity is greater than a default value. Moreover, the memory 810 can record information of the inconformity of the input signal and the starting password, such as occurrence time, for notifying the legal users.

In conclusion, the present invention can effectively enhance information security of the computer system and prevent information of the computer system from being stolen, which may cause a huge loss of individuals or enterprises.

Those skilled in the art will readily observe that numerous modifications and alterations of the device and method may be made while retaining the teachings of the invention.

What is claimed is:

1. A method of enhancing information security in a computer system comprising:
receiving an input signal;
reading a starting password;
comparing the input signal with the starting password for generating a comparison result; and
controlling an operating status of a basic input and output system (BIOS) of the computer system according to the comparison result.

2. The method of claim 1, wherein controlling the operating status of the BIOS of the computer system according to the comparison result is controlling the BIOS to perform a boot process when the comparison result indicates that the input signal conforms to the starting password, and to perform a shutdown process when the comparison result indicates that the input signal does not conform to the starting password.

3. The method of claim 1 further comprising counting times of the situation that the input signal does not conform to the starting password, and outputting an alarm signal when the counted times is greater than a default value.

4. The method of claim 1 further comprising recording information of the comparison result when the comparison result indicates that the input signal does not conform to the starting password.

5. An electronic device for enhancing information security in a computer system comprising:
a reception unit for receiving an input signal;
a reading unit for reading a starting password;
a comparison unit coupled to the reception unit and the reading unit, for comparing the input signal with the starting password for generating a comparison result; and
a control unit coupled to the comparison unit and a basic input and output system (BIOS) of the computer system, for controlling an operating status of the BIOS according to the comparison result.

6. The electronic device of claim 5, wherein the control unit is utilized for controlling the BIOS to perform a boot process when the comparison result indicates that the input signal conforms to the starting password, and to perform a shutdown process when the comparison result indicates that the input signal does not conform to the starting password.

7. The electronic device of claim 5 further comprising:
a counting unit coupled to the comparison unit, for counting times of the situation that the input signal does not conform to the starting password, and
an alarm unit coupled to the counting unit, for outputting an alarm signal when the counted times is greater than a default value.

8. The electronic device of claim 5 further comprising:
a memory coupled to the comparison unit, for recording information of the comparison result when the comparison result indicates that the input signal does not conform to the starting password.

9. The electronic device of claim 5 being embedded in a keyboard controller of the computer system.

10. A method of enhancing information security in a computer system comprising:
receiving a power-on signal;
determining a security level of the computer system after receiving the power-on signal;
outputting an indication signal according to the security level of the computer system;
receiving an input signal after outputting the indication signal;
reading a starting password;
comparing the input signal with the starting password for generating a comparison result; and
controlling an operating status of a basic input and output system (BIOS) of the computer system according to the comparison result and the security level of the computer system.

11. The method of claim 10, wherein receiving the power-on signal is performed by a power switch of the computer system.

12. The method of claim 10, wherein outputting the indication signal according to the security level of the computer system is outputting the indication signal for indicating a message of password protection when the computer system is protected by the starting password.

13. The method of claim 10, wherein controlling the operating status of the BIOS of the computer system according to the comparison result and the security level of the computer system is controlling the BIOS to perform a boot process when the computer system is protected by the starting password and the comparison result indicates that the input signal conforms to the starting password, and to perform a shutdown process when the computer system is protected by the starting password and the comparison result indicates that the input signal does not conform to the starting password.

14. The method of claim 10, wherein controlling the operating status of the BIOS of the computer system according to the comparison result and the security level of the computer system is controlling the BIOS to perform a boot process when the computer system is not protected by the starting password.

15. The method of claim 10 further comprising counting times of the situation that the input signal does not conform to the starting password, and outputting an alarm signal when the counted times is greater than a default value.

16. The method of claim 10 further comprising recording information of the comparison result when the comparison result indicates that the input signal does not conform to the starting password.

17. An electronic device for enhancing information security in a computer system comprising:
a first reception unit for receiving a power-on signal;
a security level decision unit for determining a security level of the computer system after the first reception unit receives the power-on signal;
an output unit coupled to the security level decision unit, for outputting an indication signal according to the security level of the computer system;
a second reception unit for receiving an input signal after the output unit outputs the indication signal;
a reading unit for reading a starting password;
a comparison unit coupled to the second unit and the reading unit, for comparing the input signal with the starting password for generating a comparison result; and
a control unit coupled to the security level decision unit, the comparison unit, and a basic input and output system (BIOS)of the computer system, for controlling an operating status of the BIOS according to the comparison unit and the security level of the computer system.

18. The electronic device of claim 17, wherein the first reception unit is coupled to a power switch of the computer system.

19. The electronic device of claim 17, wherein the output unit outputs the indication signal for indicating a message of password protection when the computer system is protected by the starting password.

20. The electronic device of claim 17, wherein the control unit controls the BIOS to perform a power-on process when the computer system is protected by the starting password and the comparison result indicates that the input signal conforms to the starting password, and to perform a shutdown process when the computer system is protected by the starting password and the comparison result indicates that the input signal does not conform to the starting password.

21. The electronic device of claim 17, wherein the control unit controls the BIOS to perform a power-on process when the computer system is not protected by the starting password.

22. The electronic device of claim 17 further comprising:
a counting unit coupled to the comparison unit, for counting times of the situation that the input signal does not conform to the starting password; and
an output unit coupled to the counting unit, for outputting an alarm signal when the counted times is greater than a default value.

23. The electronic device of claim 17 further comprising:
a memory coupled to the comparison unit, for recording information of the comparison result when the comparison result indicates that the input signal does not conform to the starting password.

24. The electronic device of claim 17 being embedded in a keyboard controller of the computer system.
